(19) United States
(12) Patent Application Publication
(10) Pub. No.: US 2010/0047665 A1
(43) Pub. Date: Feb. 25, 2010

(54) BOX FOR RECEIVING ELECTROMAGNETIC VALVE FOR FUEL CELL SYSTEM

(76) Inventors: Masahiro Takeshita, Toyota-shi (JP); Shigeyuki Inoue, Toyota-shi (JP)

Correspondence Address: KENYON & KENYON LLP, 1500 K STREET N.W., SUITE 700, WASHINGTON, DC, 20005, US

(21) Appl. No.: 12/531,806

(22) PCT Filed: Mar. 12, 2008
(86) PCT No.: PCT/JP2008/055026

§ 371 Date: Sep. 17, 2009

(30) Foreign Application Priority Data
Mar. 20, 2007 (JP) 2007-073037
Nov. 28, 2007 (JP) 2007-307866

(51) Int. Cl. H01M 2/00

(52) U.S. Cl. 429/34

(57) ABSTRACT

A plurality of electromagnetic valves used in a fuel cell system are protected from an external environment. A fuel cell system includes a fuel cell stack, three shut valves, a humidifier, and an electromagnetic valve receiving box provided in this order from the front side to the rear side of a vehicle. In order to protect a plurality of electromagnetic valves used in a fuel cell system, the electromagnetic valve receiving box receives a plurality of electromagnetic valves used for operations of the shut valves and connected to the shut valves via fluid channel tubes. The electromagnetic valve receiving box is formed of a base plate and a shell and has a base plate water-proof structure and an electromagnetic shielding property. The base plate having higher rigidity than the shell is provided to face the front side of the vehicle. The fluid channel tubes are aligned and provided on the top surface of the humidifier and fixed thereon.

### TECHNICAL FIELD

The present invention relates to an electromagnetic valve receiving box for a fuel cell system, which is an electromagnetic valve receiving box for a fuel cell system that receives electromagnetic valves used in a fuel cell system.

### BACKGROUND ART

Fuel cells are mounted on vehicles because they have reduced impact on the environment. In a fuel cell, for example, a fuel gas, such as hydrogen, is supplied to the anode of a fuel cell stack and an oxidizing gas containing oxygen, for example, air, is supplied to the cathode, and necessary electric power is extracted by a cell chemical reaction via an electrolyte film therein. Also, the fuel cell generates heat by the cell chemical reaction. Accordingly, as peripheral devices, the fuel cell is provided with a compressor and a pump for supplying a fuel gas and an oxidizing gas, and a cooling water pump. These peripheral devices are referred to as auxiliaries for a fuel cell stack. Hence, a fuel cell system is operated by adjusting and controlling pressures, flow rates, and so forth of fluids, such as a fuel gas, an oxidizing gas, and cooling water, in the fuel cell stack and the auxiliaries. Fluid control valves, electromagnetic control valves, and so forth are used in order to control the pressures and the flow rates of these fluids.

A fluid control valve performs control to adjust a flow rate or the like of a fluid of interest using a pressure of another fluid. An example of such a valve is a so-called shut valve that controls a channel of the fluid of interest to open and close by adjusting the internal pressure of a pressure chamber. For example, a shut valve used to open and close a channel of an oxidizing gas opens and closes the channel of the oxidizing gas by forcing a cylinder to move according to the internal pressure of the pressure chamber. For example, by forcing the cylinder to move in one direction by supplying the pressure chamber with pressurized air or by forcing the cylinder to move in the other direction by opening the pressure chamber to the atmosphere, it becomes possible to open and close the channel of the oxidizing gas. Whether pressurized air is to be supplied to the pressure chamber or the pressure chamber is to be opened to the atmosphere can be controlled by electromagnetic control valves.

As has been described, because the fuel cell system uses many components, such as auxiliaries, in addition to the fuel cell stack, it is preferable to arrange the layout of these components efficiently. Also, the mounting position of the fuel cell system in a vehicle is often in the front portion, the rear portion, or the under-floor portion of the vehicle. These portions, however, are all susceptible to the external environment. For example, these portions are subject to the influence of stones, mud, water, snow, and so forth, and these portions often undergo impact while the vehicle is running. Accordingly, it is also preferable to arrange protection that safeguards the fuel cell stack and components such as auxiliaries from the influence of the external environment.

For example, Patent Document 1 discloses a fuel cell-mounted electric vehicle in which a radiator and an air compressor are provide in the front portion, a high-pressure fuel tank is provided in the rear portion, and an FC system box is attached under the front floor substantially at the center, as an airtight container. In the FC system box, a first group including fuel cell output setting means, a thermostat, and a water pump aligned in the right-left direction, the fuel cells, a second group including fuel supply control means, a hydrogen pump, and humidifier means provided in the right-left direction, and exhaust means are provided in this order from the front side to the rear side of the vehicle. The cited reference describes that this configuration can prevent the fuel cells or the like from breaking even when an excessively large impact is applied to the vehicle from outside, which makes it possible to protect the fuel cells from water, mud, and chipping.

Patent Document 2 discloses a configuration of a fuel cell system box provided under the floor at the center of the vehicle, which is formed by attaching individual units including a cooling system unit, an FC stack and control system unit, and a humidifier system unit to a seat, and covering the entire assembly with a canopy. An air supply hole is provided in the front panel and a hydrogen exhaust hole is provided in the rear portion. The cited reference describes that this configuration protects the fuel cell system from water, mud, and chipping, which makes it possible to prevent passengers from touching a high-voltage component while preventing hydrogen from entering into the vehicle interior.

As relevant art, Patent Document 3 discloses, as a casing structure of a battery pack, to provide the casing with a plurality of bead portions that enhance rigidity against an impact on the vehicle in a direction along the front-rear direction of the vehicle. This direction is a direction perpendicular to a lamination direction of battery modules accommodated inside the battery pack. Also, because this direction is the same direction as a cooling air flowing direction inside the battery pack, there is no influence such as causing pressure loss of the cooling air. The bead portions referred to herein mean grooves provided to protrude to the inner side of the battery case.

Also, as relevant art, Patent Document 4 describes a check valve that prevents fuel vapor generated in the fuel tank from entering into the pump, and it describes the configuration to provide a filter formed of non-woven fabric between the valve body of the check valve and the housing main body in order to reduce noise and vibration.

Patent Document 1: JP-A-2004-168101

Patent Document 2: JP-A-2003-151605

Patent Document 3: JP-A-2005-302590

Patent Document 4: JP-A-2005-69103

### DISCLOSURE OF THE INVENTION

### Problems that the Invention is to Solve

In Patent Documents 1 and 2, the fuel cell system box is provided and the fuel cell stack and various auxiliaries are accommodated therein. By accommodating the fuel cell system in a single box, however, the overall box becomes larger. Hence, a mountable space inside the vehicle may not be fully utilized. On the other hand, according to the method of mounting the components forming the fuel cell system at dispersed places on the vehicle, there arises a need for an arrangement to protect individual components from the external environment. For example, in order to protect individual control devices, such as electromagnetic valves, susceptible to the external environment, from water, mud, and so forth, and protect these control devices from impact, it is necessary to make each control device waterproof and provide each control device with a special impact-resistant support, which consequently increases the cost.

An object of the invention is to provide an electromagnetic valve receiving box for a fuel cell system that protects a plurality of electromagnetic valves from the external environment.

### Means for Solving the Problems

An electromagnetic valve receiving box for a fuel cell system of the invention includes a plurality of electromagnetic valves used in a fuel cell stack or a fuel cell auxiliary, and a box casing that receives the plurality of electromagnetic valves in an interior thereof and has connection portions to a side of the fuel cell stack or a side of the fuel cell auxiliary.

Also, it is preferable that the box casing has a water-proof structure that prevents entrance of moisture from outside. Also, it is preferable that the box casing has an electromagnetic shielding structure that suppresses at least one of entrance of an electromagnetic wave from outside and radiation of the electromagnetic wave from inside to outside.

Also, in the electromagnetic valve receiving box for a fuel cell system of the invention, it is preferable that each electromagnetic valve is an electromagnetic valve that supplies a working fluid to a fluid control valve used in the fuel cell stack or the fuel cell auxiliary and operating in response to an internal pressure of a pressure chamber.

Also, in the electromagnetic valve receiving box for a fuel cell system of the invention, it is preferable that the fuel cell system is mounted on a vehicle, and that the box casing is attached to the vehicle and held therein.

Also, in the electromagnetic valve receiving box for a fuel cell system of the invention, it is preferable that the box casing is attached under a floor of the vehicle and held therein.

Also, it is preferable that the box casing has a protection outer shell surface having higher rigidity than other outer shell surfaces and is attached in such a manner that the protection outer shell surface faces a front side of the vehicle when mounted on the vehicle.

Also, it is preferable that the box casing has an inclined outer surface that is inclined to point downward in a direction of gravitational force from a front side to a rear side of the vehicle when attached to the vehicle.

Also, it is preferable that the box casing is provided on a rear side of the vehicle from the fuel cell stack or on the rear side from a humidifier stack as the fuel cell auxiliary when mounted on the vehicle.

Also, in the electromagnetic valve receiving box for a fuel cell system of the invention, it is preferable that the electromagnetic valves are connected to the side of the fuel cell stack or the side of the fuel cell auxiliary at connection portions via fluid channel tubes, and that in a case where the fuel cell stack, a humidifier, and the electromagnetic valve receiving box for a fuel cell system are provided sequentially in order of description from a front side to the rear side of the vehicle, a plurality of the fluid channel tubes connected to the connection portions of the box casing are aligned and provided along a casing of the humidifier.

Also, in the electromagnetic valve receiving box for a fuel cell system of the invention, it is preferable that the plurality of the fluid channel tubes include a plurality of pipe tubes each made of a metal pipe and fixed to the casing of the humidifier, and a plurality of flexible tubes connecting the respective pipe tubes and the corresponding connection portions of the box casing, and that the respective pipe tubes have different lengths from positions fixed to the casing of the humidifier to connection end portions to the flexible tubes.

Also, in the electromagnetic valve receiving box for a fuel cell system of the invention, it is preferable that: the electromagnetic valves are connected to fluid control valves each used in the fuel cell stack or the fuel cell auxiliary and operating in response to an internal pressure of a pressure chamber at connection portions via fluid channel tubes; each fluid control valve has a breathing port, and an input port and an output port connected to the corresponding electromagnetic valve; and the box casing has a breathing port connection portion to which the breathing port of the fluid control valve is connected while being opened to an internal space of the casing and an atmosphere open port that opens the internal space of the casing to atmosphere, and is provided in such a manner that the breathing port connection portion is at a position above the atmosphere open port with respect to a direction of gravitational force when mounted on the vehicle.

Also, in the electromagnetic valve receiving box for a fuel cell system of the invention, it is preferable that the box casing includes a bead portion having a concave shape toward an outside of the casing and a convex shape toward an inside of the casing.

Also, in the electromagnetic valve receiving box for a fuel cell system of the invention, it is preferable that filters are provided between the respective connection portions and the corresponding electromagnetic valves inside the box casing.

Also, in the electromagnetic valve receiving box for fuel cell system of the invention, it is preferable that the filters are formed of non-woven fabric.

### Advantage of the Invention

According to the configurations described above, the electromagnetic valve receiving box for a fuel cell system receives a plurality of electromagnetic valves used in the fuel cell stack or the fuel cell auxiliary in the interior thereof, and has connection portions to the side of the fuel cell stack or the side of the fuel cell auxiliary. Accordingly, it becomes possible to protect a plurality of the electromagnetic valves collectively from the external environment.

Also, because the box casing has the water-proof structure, the electromagnetic valves can be protected from water, mud, snow and so on. Also, because the box casing has the electromagnetic shielding structure, it becomes possible to suppress influences on an external control device and to prevent a malfunction of the electromagnetic valves caused by electromagnetic noise from outside.

Also, the electromagnetic valves are used to supply a working fluid to the fluid control valve that operates in response to the internal pressure of the pressure chamber. Hence, in a fuel cell system using so-called shut valves, it becomes possible to protect electromagnetic valves that control the shut valves collectively from the external environment.

Also, the electromagnetic valve receiving box for a fuel cell system is used in a fuel cell system mounted on a vehicle and the box casing is attached to the vehicle and held therein. It thus becomes possible to protect the electromagnetic valves from the external environment, such as water, mud, snow and so on, while the vehicle is running.

Also, the box casing has the protection outer shell surface having high rigidity and it is attached in such a manner that the protection outer shell surface faces the front side of the vehicle. It thus becomes possible to protect the electromagnetic valves effectively from impact while the vehicle is running.

Also, the box casing has the inclined outer surface that inclines to point downward in the direction of gravitational force from the front side to the rear side of the vehicle when attached to the vehicle. For example, when water, mud, snow and so on are splashed on the box casing while the vehicle is running, they flow down along the inclined surface.

Also, when mounted on the vehicle, the box casing is provided on the rear side of the vehicle from the fuel cell stack or on the rear side from the humidifier stack as the fuel cell auxiliary. It thus becomes possible to effectively protect the electromagnetic valves from impact while the vehicle is running.

Also, the electromagnetic valves are connected to the side of the fuel cell stack or the like at connection portions via the fluid channel tubes, and in a case where the fuel cell stack, a humidifier, and the electromagnetic valve receiving box are provided sequentially in order of description from the front side to the rear side of the vehicle, a plurality of the fluid channel tubes are aligned and provided along the casing of the humidifier. Hence, because a plurality of the fluid channel tubes are provided neatly, maintenance can be made easier.

Also, the respective pipe tubes forming a plurality of the fluid channel tubes have different lengths from positions fixed to the casing of the humidifier to connection end portions to the flexible tubes. It thus becomes possible to prevent a plurality of the fluid channel tubes from being connected to wrong connection portions of the casing box.

Also, the breathing port connection portion connected to the fluid control valve is provided at a position above the atmosphere open port with respect to the direction of gravitational force in the box casing. Hence, should water or the like enter inside from the atmosphere open port, it is possible to prevent entrance of water or the like into the fluid control valve via the breathing port.

Also, the box casing includes a bead portion having a concave shape toward the outside of the casing and a convex shape toward the inside of the casing. It thus becomes possible to enhance the rigidity of the box casing. It also becomes possible to reduce vibration sounds and operation sounds of the electromagnetic valves and so on inside the box casing.

Also, filters are provided between the respective connection portions and the corresponding electromagnetic valves inside the box casing. It thus becomes possible to prevent dirt or the like from entering into the electromagnetic valves.

Also, the filters are formed of non-woven fabric. Hence, besides the advantage that dirt or the like can be removed, it becomes possible to reduce operation sounds by suppressing propagation of vibrations of the electromagnetic valves.

### BRIEF DESCRIPTION OF THE DRAWINGS

FIG. 1 is a view showing a state where an electromagnetic valve receiving box according to an embodiment of the invention is mounted on a vehicle.

FIG. 2 is a view showing a layout relationship of components relating to the electromagnetic valve receiving box according to an embodiment of the invention.

FIG. 3 is a view used to describe a fluid channel system in a fuel cell system using the electromagnetic valve receiving box according to an embodiment of the invention.

FIG. 4 is a view used to describe the configuration of an electromagnetic valve, which is a three-way valve, according to an embodiment of the invention.

FIG. 5(A) is a view used to describe a state where the electromagnetic valve, which is a three-way valve, is not operating, according to an embodiment of the invention.

FIG. 5(B) is a view used to describe an operation state of the electromagnetic valve, which is a three-way valve, according to an embodiment of the invention.

FIG. 6(A) is a view used to describe a state where an electromagnetic valve, which is a two-way valve, is not operating, according to an embodiment of the invention.

FIG. 6(B) is a view used to describe an operation state of the electromagnetic valve, which is a two-way valve, according to an embodiment of the invention.

FIG. 7 is a perspective view showing an outward appearance of the electromagnetic valve receiving box according to an embodiment of the invention.

FIG. 8 is a view showing a cross section of the electromagnetic valve receiving box and a layout situation of fluid channel tubes, according to an embodiment of the invention.

FIG. 9 is a view showing a layout situation of the electromagnetic valve receiving box and the fluid channel tubes when viewed in a plane and a cross section of holding portions of the fluid channel tubes according to an embodiment of the invention.

FIG. 10 is a view showing a state of an electromagnetic valve receiving box provided with bead portions according to an embodiment of the invention.

FIG. 11 is a cross-sectional view of FIG. 10.

FIG. 12 is a view showing an internal layout of the electromagnetic valve receiving box when filters are provided according to an embodiment of the invention.

### DESCRIPTION OF REFERENCE NUMERALS AND SIGNS

8: foreign matter, 10: vehicle, 12, 14, and 16: under-floor members, 20: fuel cell system, 22: fuel cell stack, 24: humidifier, 26: fuel gas tank, 28: diluter, 29: muffler, 30: shut valve, 32: supply shut valve, 34: exhaust shut valve, 36: humidifier bypass shut valve, 40: oxidizing gas source, 42: ACP, 44: inter-cooler, 45: pressure regulating valve, 46: regulator, 47: flow divider, 48: exhaust valve, 49: circulation booster, 50 and 100: electromagnetic valve receiving boxes, 51: receiving space, 52 and 102: box casings, 54: base plate, 55 and 56: shells, 57 and 58: holding members, 60: external connection portion, 62, 64, 66, and 68: connection ports, 70: breathing port connection portion, 72: atmosphere open port, 74 and 76: electromagnetic valves, 77: pressure chamber, 78: opening and closing tool, 79: drive coil, 80: fluid channel tube, 82: pipe tube, 84: flexible tube, 86 and 87: fixing tools, 90: layout state of positions of the other ends of pipe tubes, 104: bead portion, and 110: filter.

### BEST MODE FOR CARRYING OUT THE INVENTION

Hereinafter, embodiments of the invention will be described in detail using the drawings. Hereinafter, descriptions will be given on the assumption that an electromagnetic valve receiving box for fuel cells is mounted on a hybrid vehicle. It should be appreciated, however, that vehicles other than a hybrid vehicle, for example, an electric vehicle having no engine, can be used as well. Also, fuel cell systems other than a fuel cell system mounted on a vehicle, for example, a stationary fuel cell system, can also be used. Further, in a case where the electromagnetic valve receiving box for a fuel cell system is mounted on the vehicle, descriptions will be given on the assumption that it is provided under the floor in the vehicle interior. It should be appreciated, however, that this configuration is a mere example and the electromagnetic valve receiving box for a fuel cell system may be provided at other places of the vehicle. Hereinafter, descriptions will be given on the assumption that electromagnetic valves in three systems each having three electromagnetic valves, that is, a total of nine electromagnetic valves, are received in the electromagnetic valve receiving box for a fuel cell system. It should be appreciated, however, that the specified number is a mere example and a different number of electromagnetic valves can be used. In addition, descriptions will be given on the assumption that each electromagnetic valve received in the electromagnetic valve receiving box for a fuel cell system is connected to a shut valve used in the fuel cell system. The electromagnetic valves, however, can be connected to components other than the shut valves. For example, electromagnetic valves for a fuel cell stack or electromagnetic valves for a fuel cell auxiliary may be collectively received in the electromagnetic valve receiving box for a fuel cell system.

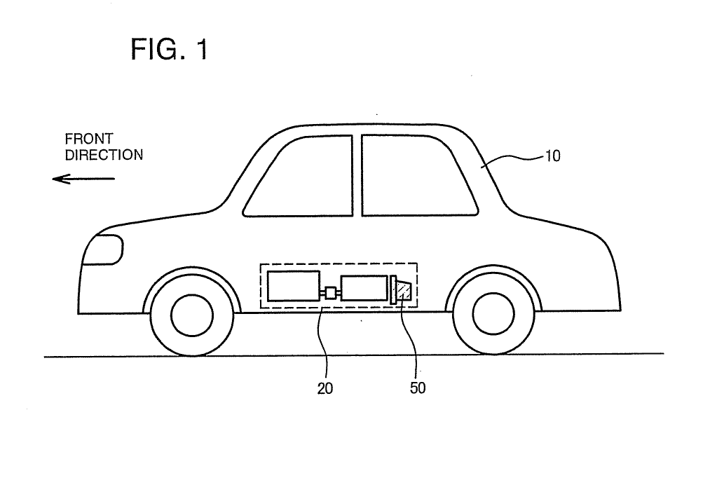

FIG. 1 is a view showing a state where a fuel cell system 20 is mounted on a vehicle 10, and it shows an electromagnetic valve receiving box 50 for a fuel cell system, as a component forming a part of the fuel cell system 20. Hereinafter, the electromagnetic valve receiving box 50 for a fuel cell system is referred to simply as the electromagnetic valve receiving box 50. As is shown in FIG. 1, the fuel cell system 20 is provided at the bottom portion of the vehicle 10, that is, under the floor in the vehicle interior. The electromagnetic valve receiving box 50 at the bottom portion of the vehicle 10 is therefore in an environment susceptible to splashing of water, snow, mud, and so forth from the roads.

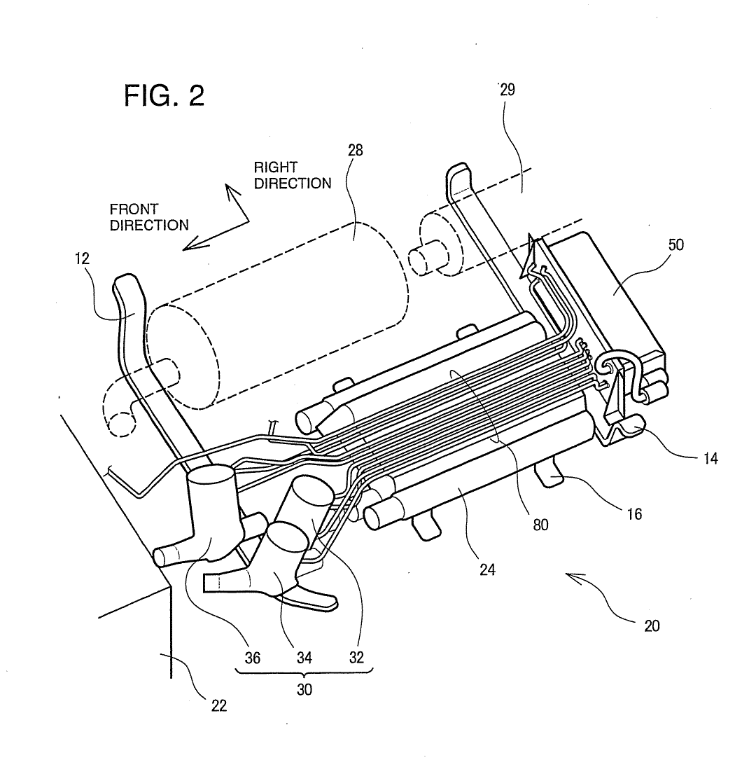

FIG. 2 is a view showing the configuration of the fuel cell system 20 and it is a view particularly showing the layout relationship of components relating to the electromagnetic valve receiving box 50. Herein, of the components forming the fuel cell system 20, a fuel cell stack 22, a humidifier 24, a diluter 28, a muffler 29, shut valves 30, and the electromagnetic valve receiving box 50 are shown. Herein, three valves, that is, a supply shut valve 32, an exhaust shut valve 34, and a humidifier bypass shut valve 36, are shown as the shut valve 30. Hereafter, these three valves are referred to as the shut valves 30 when referring to all the three shut valves, or typical shut valves, and when referring to these three shut valves individually they are specifically referred to as the supply shut valve 32, the exhaust shut valve 34, and the humidifier bypass shut valve 36.

Various fluid channel tubes for a fuel gas, an oxidizing gas, a used gas, working fluids of the shut valves 30, and so forth are laid among the respective components. For ease of understanding, connections of these tubes shown in FIG. 2 are shown broken except for fluid channel tubes 80 for a shut valve. FIG. 2 shows under-floor members 12, 14, and 16 of the vehicle. The respective components of the fuel cell system 20 are attached to these under-floor members 12, 14, and 16 and mounted on the vehicle.

In FIG. 2, the front direction and the right direction of the vehicle are indicated by arrows. More specifically, the fuel cell stack 22, the shut valves 30, the humidifier 24, and the electromagnetic valve receiving box 50 are provided in this order from the front side to the rear side of the vehicle. Also, the shut valves 30, the humidifier 24, and the electromagnetic valve receiving box 50 are provided on the left side of the vehicle toward the front. The fluid channel tubes 80 for shut valve are aligned and provided substantially in parallel with one another in the front-rear direction of the vehicle along the top surface of the humidifier 24.

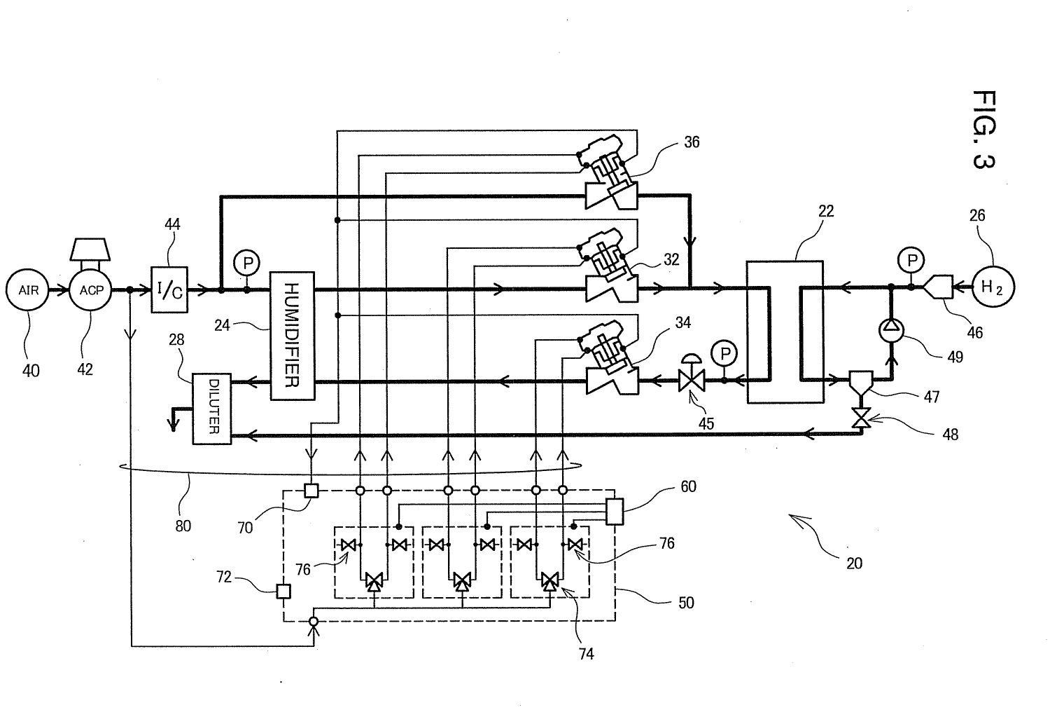

FIG. 3 is a view used to describe a fluid channel system of the fuel cell system 20. The fuel cell system 20 includes a fuel cell main body called the fuel cell stack 22 formed by laminating a plurality of fuel cells, respective components for supplying a fuel gas and provided on the anode side of the fuel cell stack 22, and respective components for supplying an oxidizing gas and provided on the cathode side.

The fuel cell stack 22 is a lamination formed by combining a plurality of unit cells. Each unit cell is formed by sandwiching an MEA (Membrane Electrode Assembly), in which catalytic electrode layers are provided on both sides of an electrolyte membrane, between separators provided on both sides of the catalytic electrode layers. The fuel cell stack 22 has a capability of extracting necessary electric power by generating electric power through a cell chemical reaction via the electrolyte membrane by supplying a fuel gas, such as hydrogen, to the anode side and by supplying an oxidizing gas containing oxygen, for example, air, to the cathode side.

A fuel gas tank 26 on the anode side is a hydrogen gas source and it is a tank that supplies hydrogen as a fuel gas. A regulator 46 connected to the fuel gas tank 26, which is a hydrogen gas source, has a capability of adjusting the gas from the fuel gas tank 26, which is a hydrogen gas source, at adequate pressure and flow rate. A pressure meter provided at the outlet of the regulator 46 is a measuring instrument that detects a supplied hydrogen pressure. The outlet of the regulator 46 is connected to the inlet on the anode side of the fuel cell stack 22, so that a fuel gas adjust at adequate pressure and flow rate is supplied to the fuel cell stack 22.

A flow divider 47 connected to the outlet on the anode side of the fuel cell stack 22 causes an exhaust gas to flow from the outlet on the anode side to the diluter 28 via an exhaust valve 48 when an impurity gas concentration in the exhaust gas increases. A circulation booster 49 provided behind the flow divider 47 and between the flow divider 47 and the inlet on the anode side is a hydrogen pump having a capability of making the gas returning from the outlet on the anode side reusable by increasing a hydrogen partial pressure and returning the gas again to the inlet on the anode side.

Atmosphere can actually be used as an oxidizing gas source 40 on the cathode side. Air from the atmosphere, which is the oxidizing gas source 40, is supplied to an air compressor (ACP) 42 via a filter. The ACP 42 is a gas booster machine that increases the pressure of an oxidizing gas by means of volume compression using a motor. Also, the ACP 42 has a capability of providing a predetermined amount of an oxidizing gas by varying the rotation velocity (number of revolutions per minute) of the motor. More specifically, when a required flow rate of an oxidizing gas is large, the rotation velocity of the motor is increased, and conversely, when a required flow rate of an oxidizing gas is small, the rotation velocity of the motor is decreased.

An inter-cooler provided downstream of the ACP 42 is a heat exchanger between a coolant that cools the fuel cell stack 22 and an oxidizing gas. More specifically, the inter-cooler has a capability of warming the cooling coolant using an oxidizing gas warmer than the cooling coolant when the temperature of the cooling coolant is low at the start-up of the fuel cell stack 22, and cooling the cooling coolant with an oxidizing gas colder than the cooling coolant when the temperature of the cooling coolant rises during steady operation of the fuel cell stack 22.

The humidifier 24 has a capability of humidifying an oxidizing gas appropriately so that the fuel cell reaction can take place efficiently in the fuel cell stack 22, and it is also referred to as a humidifier module. The oxidizing gas appropriately humidified by the humidifier 24 is supplied to the inlet on the cathode side of the fuel cell stack 22 and exhausted from the outlet on the cathode side. In this instance, water, which is a reaction product, is discharged with the exhaust. Because the fuel cell stack 22 becomes hot due to the reaction, water to be discharged is in the form of water vapor. This water vapor is returned to the humidifier 24 to appropriately humidify the oxidizing gas. As has been described, the humidifier 24 has a capability of providing adequate moisture in the form of water vapor to the oxidizing gas. Hence, a gas exchanger using a so-called hollow yarn can be used.

Herein, a channel connecting the oxidizing gas source 40 and the inlet on the cathode side of the fuel cell stack 22 can be referred to as a channel on the inlet side or a channel on the supply side. Correspondingly, a channel connected from the outlet on the cathode side of the fuel cell stack 22 to the exhaust side can be referred to as a channel on the outlet side or a channel on the exhaust side. Hence, an oxidizing gas channel, which is a channel of the oxidizing gas, goes inside the fuel cell stack 22 through the channel on the inlet side from the oxidizing gas source 40 by way of the humidifier 24, and extends to external air from the channel on the outlet side by way of the humidifier 24.

A pressure meter provided in the channel on the inlet side in front of the humidifier 24 is a measuring instrument that detects a supply gas pressure. A pressure meter provided in the channel on the outlet side after the outlet of the fuel cell stack 22 is a measuring instrument that detects a pressure of the used gas, that is, an exhaust gas pressure. Also, a pressure regulating valve 45 provided on a downstream side of the exhaust gas pressure detecting pressure meter is also referred to as a back pressure valve, and it is a valve having a capability of adjusting a flow rate of the oxidizing gas to the fuel cell stack 22 by adjusting a gas pressure at the outlet on the cathode side. For example, a valve capable of adjusting an effective aperture of the channel, such as a butterfly valve, can be used. Because the outlet of the pressure regulating valve 45 is connected to the humidifier 24 described above, a gas coming out from the pressure regulating valve 45 supplies water vapor to the humidifier 24, after which it returns again and goes into the diluter 28. The gas is then exhausted to the outside.

The diluter 28 is a buffer container that collects therein discharged water mixed with hydrogen from the exhaust valve 48 on the anode side and an exhaust mixed with water vapor on the cathode side and further mixed with hydrogen leaking through the MEA, and discharges the discharged water and the thus collected exhaust to the outside after the hydrogen concentration is adjusted to an adequate level.

The supply shut valve 32 provided in the channel on the inlet side, that is, the channel on the supply side, is provided between the humidifier 24 and the fuel cell stack 22 and connected to the both. It is an on-off valve that is normally open and closes when the operation of the fuel cell system 20 stops. The purpose of stopping a supply of the oxidizing gas by closing the channel on the supply side when an operation of the fuel cell system 20 stops is to suppress oxidation of a catalytic layer or the like contained in the fuel cell stack 22.

The exhaust shut valve 34 provided in the channel on the outlet side, that is, the channel on the exhaust side, between the fuel cell stack 22 and the humidifier 24, more concretely, between the pressure regulating valve 45 and the humidifier 24, is, as with the supply shut valve 32, an on-off valve that is normally open, and closes when an operation of the fuel cell system 20 stops.

In addition, a humidifier bypass channel is provided in the channel on the inlet side, that is, the channel on the supply side, so as to bypass the humidifier 24 in parallel with a channel that goes through the supply shut valve 32. To be more concrete, the channel on the supply side branches on the downstream side of the inter-cooler (I/C) 44 and one forms a main channel on the supply side that goes through the humidifier 24 and reaches the fuel cell stack 22 via the supply shut valve 32, while the other forms a bypass channel that bypasses the humidifier 24 and merges with the main channel on the supply side again on the downstream side of the supply shut valve 32. The humidifier bypass shut valve 36 provided in and connected to the bypass channel is an on-off valve that is normally closed and opens when the necessity arises.

The supply shut valve 32, the exhaust shut valve 34, and the humidifier bypass shut valve 36 are of substantially the same structure except that the first two valves are normally open and the humidifier bypass shut valve 36 is normally closed. These three valves are collectively referred to as the shut valves 30. The shut valves 30 are then fluid control valves each having a needle, such as a piston, that operates in response to an internal pressure of the pressure chamber.

For example, in the case of the supply shut valve provided in the channel on the supply side, it has a tube inside of which the needle, such as the piston, moves back and forth, and the inlet side of the tube is connected to the main channel on the supply side on the side of the humidifier 24 while the outlet side of the tube is connected to the main channel on the supply side on the side of the fuel cell stack 22. Because the needle normally retracts from the inside of the tube, the oxidizing gas is allowed to flow freely through the tube inside the supply shut valve 32. The flow of the oxidizing gas is blocked when the needle is forced to go inside the tube by varying the internal pressure of the pressure chamber because the tube inside the supply shut valve 32 is closed. In this manner, it is possible to block, that is, shut the flow of the oxidizing gas in the main channel on the supply side, as needed by forcing the needle to move back and forth by controlling the internal pressure of the pressure chamber.

One example of the configuration of the shut valves 30 as above can be a diaphragm shut valve 30. In this case, the needle used to open and close the tube is forced to move back and force in association with displacement of the diaphragm and two pressure chambers are provided on both sides of the diaphragm. Herein, a state where the internal pressure of the pressure chamber on one side is high whereas the internal pressure of the pressure chamber on the other side is low is defined as a first state, and a state where the internal pressure of the pressure chamber on the one side is low whereas the internal pressure of the pressure chamber on the other side is high is defined as a second state. Then, the diaphragm undergoes displacement toward the pressure chamber on the other side in the first state and the diaphragm undergoes displacement toward the pressure chamber on the one side in the second state. This configuration makes it possible to open and close the tube by forcing the needle to move back and forth. In this case, it is necessary to supply a working fluid in two pressure states at a low pressure and a high pressure to each of the two pressure chambers. Hereafter, descriptions will be continued on the assumption that the diaphragm shut valves 30 are used.

As has been described, each shut valve 30 receives a supply of a working fluid in each of the two pressure chambers. The supplied working fluid is switched between two pressure states at a high pressure and a low pressure. The switching is made in such a manner that when the working fluid supplied to the pressure chamber on the one side is at a high pressure, the working fluid supplied to the pressure chamber on the other side is at a low pressure, and conversely, when the working fluid supplied to the pressure chamber on the one side is at a low pressure, the working fluid supplied to the pressure chamber on the other side is at a high pressure. Air can be used as such a working fluid. In this case, compressed air from the ACP 42 can be used in two pressure states: a high pressure state in which the compressed air is under pressure and a low pressure state where the compressed air is opened to the atmosphere. For the compressed air to be readily opened to he atmosphere, holes opening to the atmosphere are provided to the shut valves 30. These holes are occasionally referred to as breathing ports or breathing holes.

Referring to FIG. 3, the electromagnetic valve receiving box 50 is a box that collectively receives the electromagnetic valves 74 and 76 that control a supply of the working fluid to the supply shut valve 32, the exhaust shut valve 34, and the humidifier bypass shut valve 36. As is shown in FIG. 3, one electromagnetic valve 74, which is a three-way valve, and two electromagnetic valves 76, which are two-way valves, are used for each of the supply shut valve 32, the exhaust shut valve 34, and the humidifier bypass shut valve 36. Hence, a total of nine electromagnetic valves 74 and 76 are received in the electromagnetic valve receiving box 50.

As is shown in FIG. 3, the nine electromagnetic valves 74 and 76 are connected to the supply shut valve 32, the exhaust shut valve 34, the humidifier bypass shut valve 36, and the ACP 42 by a total of seven fluid channel tubes 80. These seven tubes include a total of six tubes, that is, two tubes respectively corresponding to the two pressure chambers in each of the supply shut valve 32, the exhaust shut valve 34, and the humidifier bypass shut valve 36, and one tube connected to the output side of the ACP 42. From another viewpoint, this configuration can be described as follows. That is, one electromagnetic valve 74, which is a three-way valve, is provided to each of the supply shut valve 32, the exhaust shut valve 34, and the humidifier bypass shut valve 36, and the inlet of each electromagnetic valve 74, which is a three-way valve, is connected to the output side of the ACP 42 while the two outlets of each electromagnetic valve 74 are respectively connected to the two pressure chambers in the corresponding shut valve 30.

FIG. 3 shows a total of seven connection ports including six connection ports corresponding to the outlets of the respective electromagnetic valves 74, and one connection port corresponding to the inlets of the respective three-way valves and connected to the ACP 42. A total of these seven connection ports are connection portions that are provided to the electromagnetic valve receiving box 50, to which one end of each of a total of the seven fluid channel tubes 80 are connected.

Each electromagnetic valve 74 has one inlet and two outlets as described above, and has a capability of outputting a fluid supplied to the inlet selectively to either one of the two outlets. These outlets and inlet and the corresponding connection ports of the electromagnetic valve receiving box 50 are connected by appropriate tubes. The inlets of the electromagnetic valves 76, which are two-way valves, are connected to the tubes between the outlets of the respective electromagnetic valves 74, which are three-way valves, and the corresponding connection ports. The outlet of each electromagnetic valve 76 opens to the internal space of the electromagnetic valve receiving box 50. As will be described below, because the internal space of the electromagnetic valve receiving box 50 is open to the atmosphere, the outlet of each electromagnetic valve 76 is open to the atmosphere.

More specifically, by operating the two-way electromagnetic valve 76, the tube which is connected to the electromagnetic valve 76 being operated, which is a two-way valve, is opened to the atmosphere. As has been described above, the electromagnetic valves 76, which are two-way valves, are correspondingly connected to the two outlets of each electromagnetic valve 74, which is a three-way valve. Hence, by operating the two-way electromagnetic valve 76, the outlet of the three-way electromagnetic valve 74, on the side of the electromagnetic valve 76 being operated, which is a two-way valve, is opened to the atmosphere. As has been described, the electromagnetic valve 74, which is a three-way valve, has a capability of outputting a fluid supplied from the inlet selectively to either one of the two outlets. Hence, in a case where compressed air from the ACP is supplied to the inlet, the electromagnetic valve 76 has a capability of supplying high-pressure air to either one of the two outlets. When the two-way electromagnetic valve 76, connected to the corresponding outlet on the side to which high-pressure air is supplied, is not operated, high-pressure air is supplied to the corresponding connection port. However, when the two-way electromagnetic valve 76 is operated, because the high-pressure air is opened to the atmosphere, low-pressure air is supplied to the corresponding connection port.

Hence, by performing the control as follows, it becomes possible to perform switching control in such a manner that high-pressure air from the ACP 42 is supplied to one of the two pressure chambers in the shut valve 30 and low-pressure air opened to the atmosphere is supplied to the other pressure chamber first, and then the high-pressure air from the ACP 42 is supplied to the other one of the two pressure chambers and low-pressure air opened to the atmosphere is supplied to the one pressure chamber.

More specifically, high-pressure air from the ACP 42 is supplied to the inlet of the three-way electromagnetic valve 74, and the two-way electromagnetic valve 76 connected correspondingly to one of the two outlets is not operated while the two-way electromagnetic valve 76, connected correspondingly to the other one of the two outlets, is operated. The high-pressure air from the ACP 42 is then selectively supplied to one of the two outlets by controlling the operation of the three-way electromagnetic valve 74. Accordingly, the high-pressure air is supplied to the connection port corresponding to the one outlet of the three-way electromagnetic valve 74, while low-pressure opened to the atmosphere is supplied to the connection port corresponding to the other outlet of the three-way electromagnetic valve 74. Hence, at the corresponding shut valve 30, high-pressure air is supplied to the one pressure chamber connected to the connection port corresponding to the one outlet of the three-way electromagnetic valve 74, and low-pressure air opened to the atmosphere is supplied to the other pressure chamber connected to the connection port corresponding to the other outlet of the three-way electromagnetic valve 74.

A case contrary to the above case is as follows. That is, high-pressure air from the ACP 42 is supplied to the inlet of the three-way electromagnetic valve 74, and the two-way electromagnetic valve 76 that is connected correspondingly to the other one of the two outlets is not operated while the two-way electromagnetic valve 76, connected correspondingly to the one of the two outlets, is operated. The high-pressure air from the ACP 42 is then supplied selectively to the other one of the two outlets by controlling an operation of the three-way electromagnetic valve 74. Accordingly, the high-pressure air is supplied to the connection port corresponding to the other outlet of the three-way electromagnetic valve 74, while low-pressure air opened to the atmosphere is supplied to the connection port corresponding to the one outlet of the three-way electromagnetic valve 74. Hence, at the corresponding shut valve 30, low-pressure air opened to the atmosphere is supplied to the one pressure chamber connected to the connection port corresponding to the one outlet of the three-way electromagnetic valve 74, and high-pressure air is supplied to the other pressure chamber connected to the connection port corresponding to the other outlet of the three-way electromagnetic valve 74.

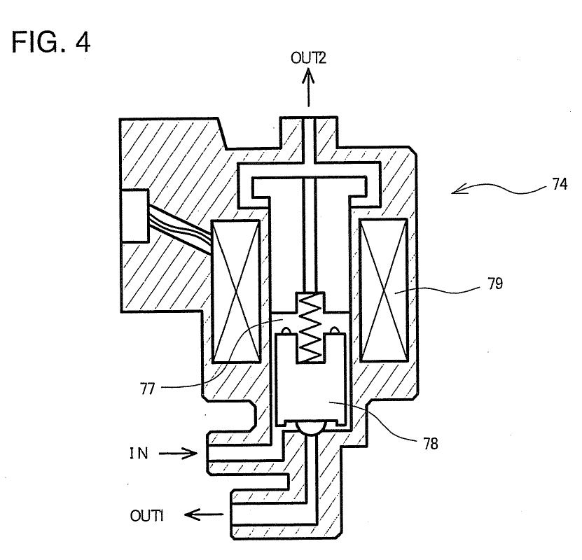

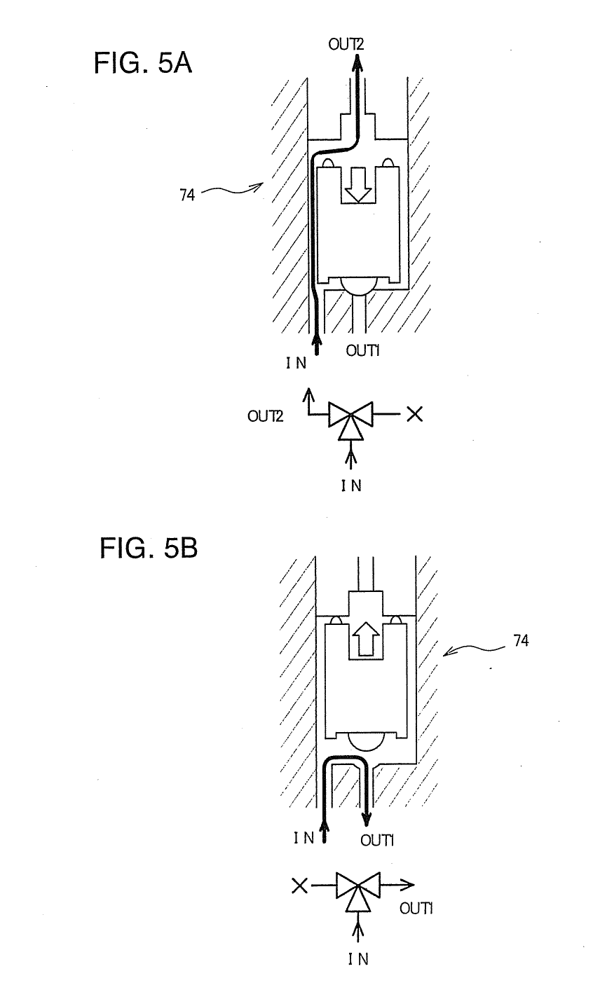

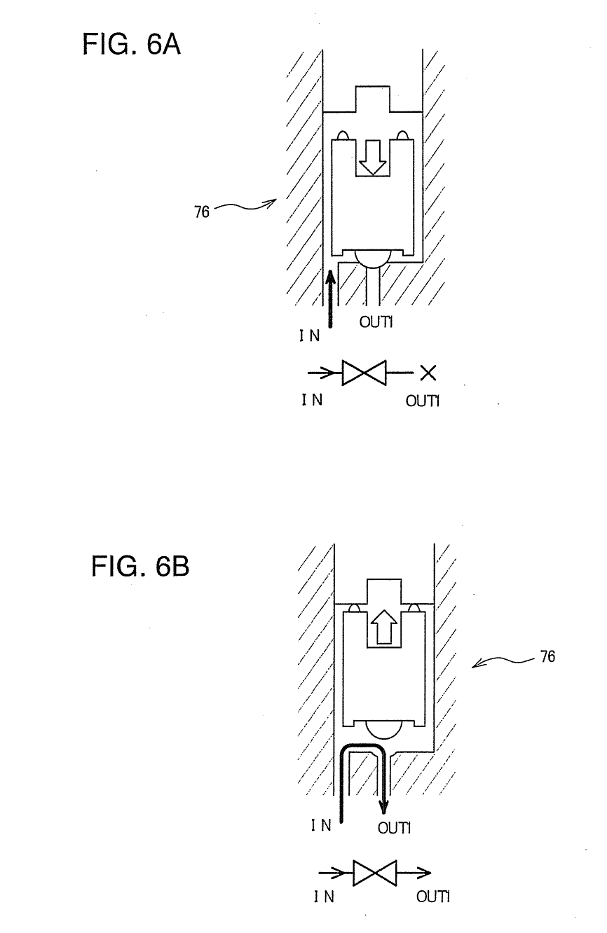

The configurations and operations of the three-way electromagnetic valve 74, and the two-way electromagnetic valve 76, will now be described using FIG. 4 through FIG. 6. FIG. 4 is a view used to describe the configuration of the three-way electromagnetic valve 74. FIG. 5 is a view used to describe an operation of the three-way electromagnetic valve 74. FIG. 6 is a view used to describe an operation of the two-way electromagnetic valve 76.

As is shown in FIG. 4, the three-way electromagnetic valve 74, has one inlet indicated as IN and two outlets indicated as OUT1 and OUT2. A pressure chamber 77 connected to each of IN, OUT1, and OUT2 is provided in the interior. An opening and closing tool 78 allowed to move in the up-down direction on the sheet surface of FIG. 4 by a drive coil 79 is provided inside the pressure chamber 77. When the drive coil 79 is not operating, the opening and closing tool 78 is pushed downward in the sheet surface of FIG. 4 by appropriate pushing means so as to block off the connection port communicating with OUT1. Accordingly, IN and OUT2 communicate with each other and a fluid supplied from IN is outputted to OUT2. This state is shown in FIG. 5(A). Herein, when the drive coil 79 shown in FIG. 4 starts to operate, the opening and closing tool 78 receives a drive force exerting upward in the sheet surface of FIG. 4 by the magnetic field induced by the drive coil 79 and moves upward against the pushing force from the pushing means. The opening and closing tool 78 therefore moves away from the connection port communicating with OUT1 and blocks off the connection port communicating with OUT2. IN and OUT1 therefore communicate with each other and the fluid supplied from IN flows to OUT1. This state is shown in FIG. 5(B).

The two-way electromagnetic valve 76 has the structure of the three-way electromagnetic valve 74, but omitting OUT2. In short, it is of a structure having only IN and OUT1. The other components are the same as those of the three-way electromagnetic valve 74. Hence, while the drive coil is not operating, OUT1 is blocked off and a fluid supplied from IN is blocked and is not outputted to OUT1. This state is shown in FIG. 6(A). When the drive coil starts to operate, the OUT1 opens and the fluid supplied from IN is outputted to OUT1. This state is shown in FIG. 6(B).

Referring to FIG. 3 again, an external connection portion 60 provided to the electromagnetic valve receiving box 50 is a connection terminal portion to which are connected electrical signal lines that are connected to the drive coils of the respective nine electromagnetic valves 74 and 76 received in the electromagnetic valve receiving box 50. The external connection portion 60 is connected to an unillustrated control portion via a control cable and operations of the respective electromagnetic valves 74 and 76 are controlled under the control of the control portion.

Also, referring to FIG. 3, a breathing port connection portion 70 provided to the electromagnetic valve receiving box 50 is a connection port connected to the breathing ports of the respective supply shut valve 32, exhaust shut valve 34, and humidifier bypass shut valve 36. The breathing port connection portion 70 is open to the internal space of the electromagnetic valve receiving box 50. More specifically, the breathing ports of the respective supply shut valve 32, exhaust shut valve 34, and humidifier bypass shut valve 36 are connected to the internal space of the electromagnetic valve receiving box 50, so that the pressure of the internal space of the electromagnetic valve receiving box 50 is supplied to the breathing ports of the respective supply shut valve 32, exhaust shut valve 34, and humidifier bypass shut valve 36.

Also, referring to FIG. 3, an atmosphere open port 72 provided to the electromagnetic valve receiving box 50 is a connection port connected to an atmosphere opening pipe that is extended to an appropriate region of the vehicle to open at the extended end. The appropriate region of the vehicle at which the atmosphere opening pipe opens can be, for example, an engine compartment. As with the breathing port connection portion 70, the atmosphere open port 72 is opened to the internal space of the electromagnetic valve receiving box 50. The internal space of the electromagnetic valve receiving box 50 is therefore at an atmospheric pressure via the atmosphere opening pipe.

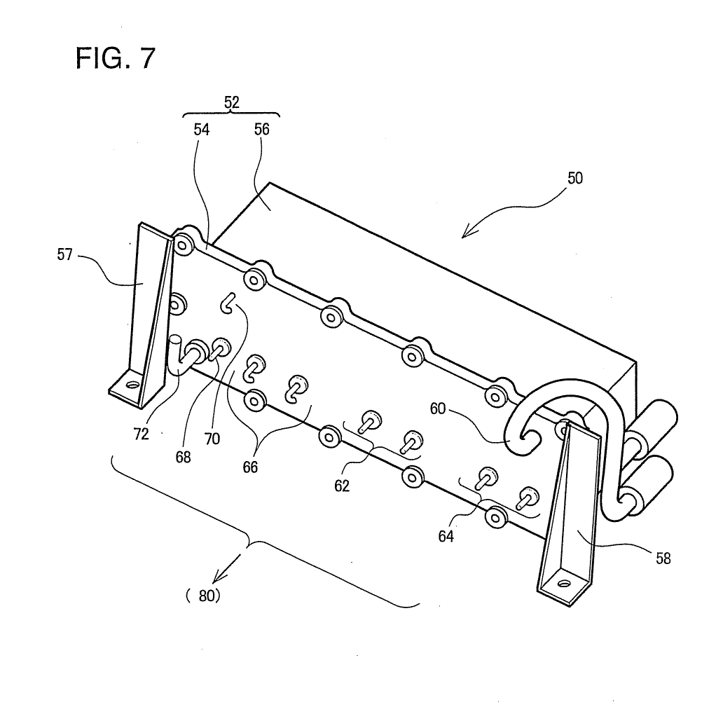

FIG. 7 is a perspective view showing an outward appearance of the electromagnetic valve receiving box 50. Hereinafter, descriptions will be given using reference numerals used in FIG. 1 through FIG. 6 when the necessity arises. FIG. 7 shows a state where holding members 57 and 58 for holding the electromagnetic valve receiving box 50 when mounted on the vehicle are attached to the electromagnetic valve receiving box 50. The holding members 57 and 58 are angular members fixedly attached to the electromagnetic valve receiving box 50 and each has an attachment hole at an end portion for fixed attachment to the under-floor members. It becomes possible to fix the electromagnetic valve receiving box 50 to the under-floor members of the vehicle using the attachment holes with appropriate fastening members.

The electromagnetic valve receiving box 50 is a box-shaped member having an internal space in the interior in which to receive the electromagnetic valves. It includes a box casing 52 formed of a base plate 54 and a shell 56, and peripheral parts.

The base plate 54 forming the box casing 52 is a plate-shaped member having adequate thickness and rigidity. It is provided with the nine connection ports connected to the fluid channel tubes 80 and the external connection portion 60 connected to the unillustrated control portion both described with reference to FIG. 3. In FIG. 7, the nine connection ports are shown as two connection ports 62 connected to the supply shut valve 32, two connection ports 64 connected to the exhaust shut valve 34, two connection ports 66 connected to the humidifier bypass shut valve 36, a connection port 68 connected to the ACP 42, the breathing port connection portion 70 connected to the breathing port of the shut valve 30, and the atmosphere open port 72.

Herein, seven ports including the two connection ports 62 connected to the supply shut valve 32, the two connection ports 64 connected to the exhaust shut valve 34, the two connection ports 66 connected to the humidifier bypass shut valve 36, and the connection port 68 connected to the ACP 42 are provided substantially in one line. In other words, when the electromagnetic valve receiving box 50 is mounted on the vehicle, these connection ports are provided at substantially the same height with respect to the direction of gravitational force. In comparison with the height at which these seven ports are provided, the breathing port connection portion 70 is provided at a significantly high position whereas the atmosphere open port 72 is provided at a relatively low position. In other words, a considerable difference in height is provided between the position at which the breathing port connection portion 70 is provided and the position at which the atmosphere open port 72 is provided with respect to the direction of gravitational force. Herein, the breathing port connection portion 70 is provided at the higher position and the atmosphere open port 72 is provided at the lower position. This configuration makes it possible to protect the shut valves 30 even when water or the like enters inside from the atmosphere open port 72 because it is possible to prevent water that has entered inside from reaching the breathing port connection portion 70.

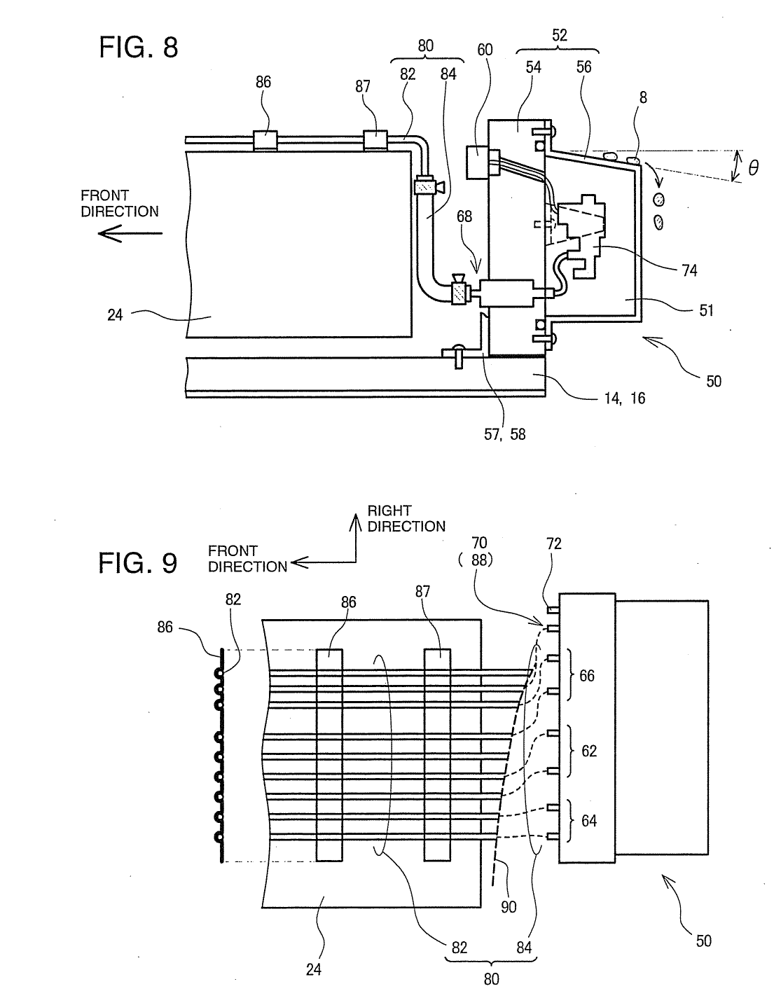

The detailed structure of the electromagnetic valve receiving box 50 and the detailed layout state of the fluid channel tubes 80 will now be described using FIG. 8 and FIG. 9. Hereinafter, descriptions will be given using the reference numerals used in FIG. 1 through FIG. 7. FIG. 8 is a cross section of the electromagnetic valve receiving box 50 along a plane parallel to the front-rear direction of the vehicle, and it is also a view showing the layout state of the fluid channel tubes 80. FIG. 9 is a plan view corresponding to FIG. 8 and a cross section of holding portions of the fluid channel tubes 80 is shown on the left side of the plan view.

As has been described with reference to FIG. 2, the electromagnetic valve receiving box 50 is provided behind the fuel cell stack 22 and the humidifier 24 provided in this order from the front side of the vehicle. Also, as has been described, the box casing 52 containing the base plate 54 and the shell 56 is formed in the electromagnetic valve receiving box 50. As is shown in FIG. 9, the box casing 52 is provided in such a manner that the base plate 54 is on the front side of the vehicle and the shell 56 is on the rear side of the vehicle. The plate surface of the base plate 54 is provided to be substantially perpendicular to the travel direction of the vehicle. The base plate 54 thus serves as a protection outer shell surface like a protection barrier for the electromagnetic valves and the like provided inside the shell 56. This configuration makes it possible to protect the electromagnetic valves from obstacles from the external environment, for example, rain, snow, mud, stones, and so on, falling thereon from the front side while the vehicle is running. This configuration also makes it possible to protect the electromagnetic valves and the like from an external force, such as an impact exerted from the front side of the vehicle. In terms of protection against an impact, it is preferable that the base plate 54 is of a structure having high rigidity in comparison with the shell 56.

The shell 56 is a bowl-shaped member having a rectangular opening portion and an adequate depth. A flange portion is provided on the periphery of the opening portion. It is preferable to form the flange portion to have flatness with which a clearing will not be produced noticeably when the shell 56 is joined to the back surface of the base plate 54, that is, when it is joined to the side face that comes on the rear side of the vehicle when mounted on the vehicle. The flange portion is provided with a plurality of attachment holes to attach the shell 56 to the base plate 54. The shell 56 and the base plate 54 are made into one unit using these attachment holes, with appropriate fastening members. The box casing 52 having a receiving space 51 in which to provide the electromagnetic valves 74 and so forth is thus formed. As is shown in FIG. 9, it is preferable to provide an appropriate seal member between the flange portion and the back surface of the base plate 54 when the shell 56 and the base plate 54 are made into one unit.

The box casing 52 in the form of one unit is an airtight container having a water-proof structure except for the main surface of the base plate 54, that is, the external connection portion 60 provided on the side surface that is situated at the rear side of the vehicle when mounted on the vehicle, and a plurality of the connection port 62 and so forth connected to the fluid channel tubes 80. This configuration makes it possible to protect the electromagnetic valves from the external environment containing moisture, such as water, mud, and snow.

It is preferable to form the side surface of the shell 56 to have adequate inclination in the box casing 52. As is shown in FIG. 8, this inclination is provided to the upper surface that becomes the ceiling side when the box casing 52 is attached to the vehicle, and the inclination points downward in the direction of gravitational force from the front side to the rear side of the vehicle. This configuration allows fluid foreign matter 8 containing moisture, such as rain, snow, and mud, that is splashed on the box casing 52 to flow downward along the inclined surface or fall off by gravitational force. It is therefore possible to prevent the fluid foreign matter 8 containing moisture from adhering to or accumulating in the box casing 52. It is preferable to set the angle of inclination “θ” of the inclined surface from about 5 degrees to about 30 degrees and pointing downward with respect to the horizontal plane.

Also, by forming the box casing from a material having an electromagnetic shielding property, it becomes possible to suppress at least one of entrance of an electromagnetic wave from the outside and radiation of an electromagnetic wave from the electromagnetic valves in the interior to the outside.

The box casing 52 as described above can be obtained by forming the base plate 54 and the shell 56 from appropriate metal materials and making these two components into one unit using an appropriate seal member and fastening members, as described above. As has been described, because it is preferable for the base plate 54 to have higher rigidity than the shell 56, for example, a metal plate having a sufficient plate thickness can be used as a material of the base plate 54, and a metal plate having an adequate plate thickness can be used as a material of the shell 56 by taking the moldability into account.

For instance, an aluminum flat plate having a plate thickness of about 3 mm to about 7 mm, a width of about 200 mm to about 400 mm, and a height of about 100 mm to about 200 mm and processed appropriately can be used as the base plate 54. Also, an aluminum plate having a plate thickness of about 1 mm to 3 mm can be used as the shell 56 and the aluminum plate is molded and processed to have the opening portion slightly smaller than the outer shape of the base plate 54 and a depth of about 30 mm to about 60 mm. However, it goes without saying that metal materials other than aluminum, for example, an iron plate and a stainless steel plate, can also be used. Alternatively, plastic having adequate rigidity can be used as a material, and this plastic is molded to a desired shape and coated with an appropriate electromagnetic shielding layer.

In FIG. 8, the cross section of the electromagnetic valve receiving box 50 shows a state where the three-way electromagnetic valve 74 is provided in the receiving space 51 in the interior of the box casing 52. As has been described, a total of nine electromagnetic valves are provided in the receiving space 51. However, one three-way electromagnetic valve 74 is only shown herein as an example. As is indicated by a broken line in part in FIG. 8, the electromagnetic valve 74 is attached to and supported on the base plate 54 by appropriate supporting members. An electrical signal line from the electromagnetic valve 74 is guided to the external connection portion 60 by way of an appropriate line through-hole provided to the base plate 54. Appropriate seal members are provided to the line through-hole and the external connection portion 60 so as to prevent entrance of moisture or the like from outside through the line through-hole and the external connection portion 60.

Also, as has been described, the three-way electromagnetic valve 74 has one inlet and two outlets, and each is connected to the corresponding connection port of the base plate 54. FIG. 8 shows a portion from the inlet to the connection to the connection port 68 as an example. More specifically, the base plate 54 is provided with an appropriate connection tube member that penetrates through in the plate thickness direction, and an appropriate fluid channel tube from the inlet of the three-way electromagnetic valve 74, for example a tube, is connected to the end portion on the side of the receiving space of the connection tube member. The end portion of the connection tube member protruding to the main surface of the base plate 54 is shown as the connection port 68. A metal tube embedded in an appropriate bush or the like can be used as the connection tube member. An appropriate seal member is provided between the connection tube member and the base plate 54 in order to prevent moisture or the like from entering inside from outside.

As has been described, nine connection ports are provided on the main surface of the base plate 54 of the box casing 52 and the fluid channel tube 80 is connected to each of these connection ports. As shown in FIGS. 8 and 9, the fluid channel tube 80 includes a pipe tube 82 provided on the top surface of the humidifier 24 and a flexible tube 84 provided along the rear surface of the humidifier 24. The pipe tube 82 is connected to the shut valve 30 at one end and connected to one end of the flexible tube 84 at the other end. The other end of the flexible tube 84 that is connected to the other end of the pipe tube 82 at one end is connected to the connection port 68 or the like provided to the base plate 54 of the box casing 52. A connection portion between the pipe tube 82 and the flexible tube 84 and a connection portion between the flexible tube 84 and the connection port are fastened securely with appropriate fastening tools so that a gas will not leak.

The pipe tubes 82 are pipes made of a material having adequate strength and adequately good thermal conductivity and provided on the top surface portion of the casing of the humidifier 24 while aligned in parallel with one another. They are fixed to the casing of the humidifier 24 using appropriate fixing tools 86 and 87 from above. Stainless steel pipes having an adequate tube diameter can be used as such pipe tubes 82.

The fixing tools 86 and 87 are members having a capability of fixing a plurality of the pipe tubes 82 collectively to the humidifier 24. The fixing tools 86 and 87 are plate members made of a material having adequate strength and adequately good thermal conductivity, and they are members molded so as to come into close contact with the outer periphery of the pipe tubes 82. This state is shown in the cross section on the left side of FIG. 9. The fixing members 86 and 87 can be metal thin plates that are deformable with a small external force and provided to cover the top surfaces of the respective pipe tubes 82 aligned, and provided on the top surface portion of the humidifier 24 and shaped to go along the outer shape of the respective pipe tubes 82 with an application of an adequate external force. It goes without saying that a member molded in advance according to the positional relationship with a plurality of the pipe tubes 82 aligned and provide on the humidifier 24 can be used as the fixing tools 86 and 87.

As has been described, by forming the pipe tubes 82 and the fixing tools 86 and 87 from a material having adequately good thermal conductivity and fixing them to the casing of the humidifier 24, it becomes possible to make a temperature of the pipe tubes 82 substantially the same as the temperature of the humidifier 24. It is therefore possible to suppress the influence of the external temperature on the working fluid of the shut valves 30.

The flexible tube 84 is a tube having adequate flexibility and a capability of providing a degree of freedom to the connection between the pipe tube 82 and the connection port 68 or the like. A rubber pipe and a plastic pipe, such as a vinyl tube, can be used as the flexible tube 84. The flexible tube 84 is not fixed to the rear surface of the humidifier 24 and can take an undefined shape within the limitation of a length between the connection position of the pipe tube 82 and the connection position of the connection port. It goes without saying, however, that the flexible tube 84 can be fixed appropriately to the rear side surface of the humidifier 24.

Herein, the position of the other end of the pipe tube 82, that is, the connection position to the flexible tube 84, is set to differ from one pipe tube 82 to another. In the plan view of FIG. 9, a layout state 90 of the position at the other end of each pipe tube 82 is indicated by a thick line. More specifically, each pipe tube 82 is set in such a manner that the length from the position where the pipe tubes 82 is fixed to the casing of the humidifier 24 to the connection portion to the flexible tube 84 differ from one pipe tube 82 to another. By providing the respective pipe tubes 82 so that the positions of the other ends differ from one another in this manner, the pipe tubes 82 can be readily discriminated from each other. It thus becomes possible to prevent connection to a wrong connection port.

In the case above, as shown in FIG. 8, for example, the electromagnetic valve receiving box 50 has the box casing 52 formed by combining the shell 56 and the base plate 54. The electromagnetic valves 74 and 76 are received in the receiving space 51 defined by the shell 56 and the base plate 54. The shell 56 is a bowl-shaped member but the wall surfaces of the casing are simple flat plates. Accordingly, the outer shape may be deformed when it is molded, for example, by means of deep drawing. In addition, the electromagnetic valves 74 and 76 generate vibration sounds or operation sounds while they are operating and these sounds may be amplified on the bowl-shaped surface of the shell 56 and become loud radiated sounds.

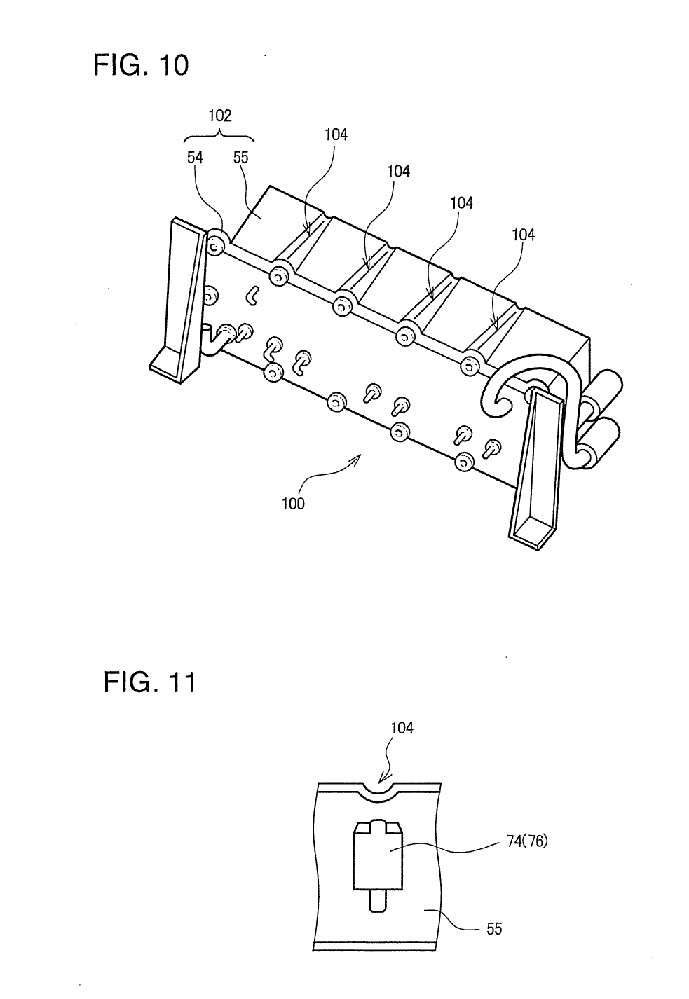

In order to enhance the moldability of the shell and to suppress operation sounds of the electromagnetic valves from becoming loud sounds through radiation and resonance within the receiving space, an example of the shell whose shape is improved will now be described. Hereinafter, similar components are labeled with similar reference numerals with respect to FIG. 1 through FIG. 9, and detailed descriptions are omitted. Also, hereinafter, descriptions will be given using numeral references used in FIG. 1 through FIG. 9. FIG. 10 is a view showing an electromagnetic valve receiving box 100 using a box casing 102 having a shell 55 provided with bead portions 104.

Herein, the bead portions 104 are grooves that are concave toward the outside of the casing and convex toward the inside of the casing with respect to the plate member forming the shell 55. The bead portions 104 are provided along a direction perpendicular to the longitudinal direction of the shell 55. FIG. 10 shows a state where four bead portions are provided on the top surface of the shell 55. FIG. 11 is a cross section along the longitudinal direction of the shell 55. As has been described, the bead portions 104 are grooves formed in such a manner that the convex portions are present on the inner side of the casing when the plate member is deep drawn.

As has been described above, by providing the bead portions 104 on the top surface of the shell 55 in a direction perpendicular to the longitudinal direction of the shell 55, it becomes possible to enhance the moldability by suppressing deformation occurring during deep drawing in comparison with a case where no bead portions 104 are provided. It also becomes possible to enhance the rigidity against an impact or the like in a direction perpendicular to the longitudinal direction of the shell 55. Owing to the enhancement in rigidity, it becomes possible to suppress vibrations of the shell 55 caused by operation sounds of the electromagnetic valves 74 and 76. In addition, because the beads portions 104 are convex portions toward the inside of the casing, a kind of concaves and convexes are consequently formed on the wall surfaces. Sound absorbency can therefore be enhanced. It thus becomes possible to make noises smaller by suppressing resonance of vibration sounds and operation sounds generated by the electromagnetic valves 74 and 76 provided in the receiving space inside the casing. As has been described with reference to FIG. 8, when inclination is provided to the top surface of the shell 55 so as to let the fluid foreign matter 8 flow or fall off, the grooves defined by the bead portions 104 make an effective contribution.

Besides providing the bead portions 104 on the top surface of the shell 55, it goes without saying that the bead portions 104 can be provided to the bottom surface or the side surfaces as the necessity arises. Alternatively, instead of setting the extending direction of the bead portions 104 to a direction perpendicular to the longitudinal direction of the shell 55, the extending direction of the bead portions 104 may be set to another direction. For example, by providing the bead portions 104 to extend in the longitudinal direction of the shell 55, the rigidity in this direction can be enhanced.

The above has described a case where a plurality of electromagnetic valves are provided in the electromagnetic valve receiving box and connected to the external shut valves at the connection ports. Herein, a filter can be provided in order to prevent foreign matter from entering into the electromagnetic valves and the like, and to prevent operation sounds of the electronic valves from propagating to the outside. Hereinafter, similar components are labeled with similar reference numerals with respect to FIG. 1 through FIG. 9 and detailed descriptions are omitted. Also, descriptions will be given using the reference numerals used in FIG. 1 through FIG. 9.

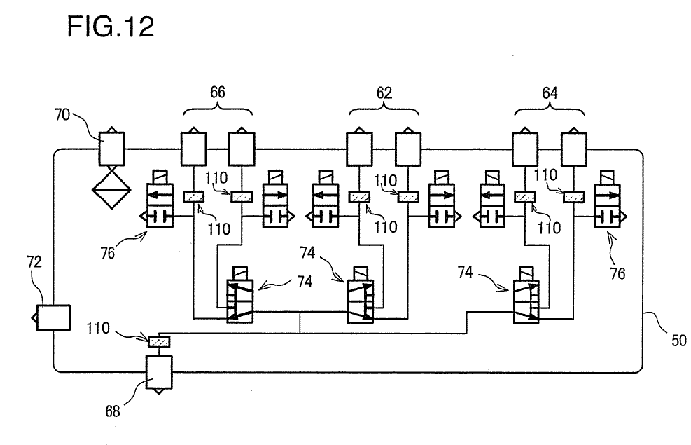

FIG. 12 is a view showing the internal layout of the electromagnetic valve receiving box 50. Herein, filters 110 are provided in channels connecting the respective connection ports 62, 64, 66, and 68 and the respective electromagnetic valves 74 and 76. To be more concrete, the filters 110 are provided at points where the respective connection ports 62, 64, 66, and 68 are attached to the electromagnetic valve receiving box 50. It is preferable to attach the respective connection ports 62, 64, 66, and 68 to the electromagnetic valve receiving box 50 with the filters 110 in between. When configured in this manner, it becomes possible to effectively prevent the operation sounds of the electromagnetic valves 74 and 76 from propagating via tubes forming the channels and consequently causing the electromagnetic valve receiving box 50 to vibrate.

In terms of vibration absorbency, as such filters 110, for example, filters formed of non-woven fabric and therefore having good flexibility are more preferable than mesh filters made of metal. It goes without saying that the filters 110 prevent foreign matter from entering into the electromagnetic valves 74 and 76.

### INDUSTRIAL APPLICABILITY

The electromagnetic valve receiving box for a fuel cell system of the invention can be used in a fuel cell system provided with a plurality of electromagnetic valves.

1. An electromagnetic valve receiving box for a fuel cell system, comprising:
a plurality of electromagnetic valves used in a fuel cell stack or a fuel cell auxiliary as a fuel cell peripheral device; and
a box casing that receives the plurality of electromagnetic valves and has a plurality of connection ports, wherein:
each of the plurality of connection ports is connected to an inlet or an outlet for a fluid of each of the electromagnetic valves inside the box casing, and outside the box casing, each of fluid channel tubes connected to a side of the fuel cell stack or a side of the fuel cell auxiliary at one end is connected to each of the plurality of connection ports at the other end; and
the fuel cell system is mounted on a vehicle, and the fuel cell stack and the electromagnetic valve receiving box for a fuel cell system are provided in order of description from a front side to a rear side of the vehicle.

2. The electromagnetic valve receiving box for a fuel cell system according to claim 1, wherein:
the box casing has a water-proof structure that prevents entrance of moisture from outside.

3. The electromagnetic valve receiving box for a fuel cell system according to claim 1, wherein:
the box casing has an electromagnetic shielding structure that suppresses at least one of entrance of electromagnetic waves from outside and radiation of electromagnetic waves from inside to outside.

4. The electromagnetic valve receiving box for a fuel cell system according to claim 1, wherein:
each electromagnetic valve is an electromagnetic valve that supplies a working fluid to a fluid control valve used in the fuel cell stack or the fuel cell auxiliary, and has a pressure chamber and a needle that operates in response to an internal pressure of the pressure chamber.

5. The electromagnetic valve receiving box for a fuel cell system according to claim 1, wherein:
the box casing is attached to the vehicle and held therein.

6. The electromagnetic valve receiving box for a fuel cell system according to claim 5, wherein:
the box casing is attached under a floor of the vehicle and held therein.

7. The electromagnetic valve receiving box for a fuel cell system according to claim 5, wherein:
the box casing has a protection outer shell surface having higher rigidity than other outer shell surfaces, and is attached in such a manner that the protection outer shell surface faces the front side of the vehicle when mounted on the vehicle.

8. The electromagnetic valve receiving box for a fuel cell system according to claim 5, wherein:
the box casing has an inclined outer surface that is inclined to point downward in a direction of gravitational force from the front side to the rear side of the vehicle when attached to the vehicle.

9. The electromagnetic valve receiving box for a fuel cell system according to claim 5, wherein:
the box casing is provided on the rear side of the vehicle from the fuel cell stack or on the rear side from a humidifier stack as the fuel cell auxiliary when mounted on the vehicle.

10. The electromagnetic valve receiving box for a fuel cell system according to claim 9, wherein:
the fuel cell stack, a humidifier, and the electromagnetic valve receiving box for a fuel cell system are provided sequentially in order of description from the front side to the rear side of the vehicle; and
the plurality of fluid channel tubes connected to the connection ports of the box casing are aligned and provided along a casing of the humidifier.

11. The electromagnetic valve receiving box for a fuel cell system according to claim 10, wherein:
the plurality of fluid channel tubes include a plurality of pipe tubes each made of a metal pipe and fixed to the casing of the humidifier, and a plurality of flexible tubes connecting the respective pipe tubes and the corresponding connection ports of the box casing; and
the respective pipe tubes have different lengths from positions fixed to the casing of the humidifier to connection end portions to the flexible tubes.

12. The electromagnetic valve receiving box for a fuel cell system according to claim 5, wherein:
the electromagnetic valves are connected to fluid control valves each used in the fuel cell stack or the fuel cell auxiliary and having a pressure chamber and a needle that operates in response to an internal pressure of the pressure chamber at the connection ports of the box casing via the fluid channel tubes;
each fluid control valve further has a breathing port opened to the atmosphere to readily open the pressure chamber to the atmosphere; and
the box casing has a breathing port connection portion connected to the breathing port of the fluid control valve while opening the breathing port to an internal space of the casing, and an atmosphere open port that opens the internal space of the casing to the atmosphere, and is provided in such a manner that the breathing port connection portion is at a position above the atmosphere open port with respect to a direction of gravitational force when mounted on the vehicle.

13. The electromagnetic valve receiving box for a fuel cell system according to claim 1, wherein:
the box casing includes a bead portion having a concave shape toward an outside of the casing and a convex shape toward an inside of the casing.

14. The electromagnetic valve receiving box for a fuel cell system according to claim 1, wherein:
filters are provided in channels connecting the respective connection ports and the respective electromagnetic valves inside the box casing.

15. The electromagnetic valve receiving box for a fuel cell system according to claim 14, wherein:
the filters are formed of non-woven fabric.
